(19) United States
(12) Patent Application Publication
(10) Pub. No.: US 2003/0151504 A1
(43) Pub. Date: Aug. 14, 2003

(54) Vehicular component with electroluminescent signaling device

(76) Inventor: Kao-Youn Chang, Kaohsiung Hsien (TW)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/075,508

(22) Filed: Feb. 14, 2002

(51) Int. Cl. B60Q 1/26

(52) U.S. Cl. 340/468; 340/463

(57) ABSTRACT

A vehicular component includes a body part and an electroluminescent signaling device. The signaling device includes a flexible electroluminescent light source strand mounted on the body part, and is adapted to be connected to and controlled by a light controller of a vehicle so as to enable the light source strand to radiate a light output for signaling purposes.

### BACKGROUND OF THE INVENTION

1. Field of the Invention

The invention relates to vehicular components, more particularly to a vehicular component with an electroluminescent signaling device.

2. Description of the Related Art

Referring to FIG. 1, a conventional vehicle 1 is generally provided with directional lights 11 at front and rear ends thereof (only those at the rear end are visible) for warning other vehicles when turning or changing lanes. However, when the vehicle 1 is relatively long, and a smaller vehicle is beside the vehicle 1, activation of the directional lights 11 might not be visible to the driver of the smaller vehicle. In such a situation, road accidents are likely to occur, especially when the smaller vehicle is hidden from the driver of the longer vehicle 1 due to limitations in the optical properties of rearview and sideview mirrors on the longer vehicle 1.

FIG. 2 illustrates a conventional vehicular component, in the form of a sideview mirror 21, which is provided with a light source 23 on a rear side thereof. The light source 23 is operable concurrently with directional lights 22 (only one is shown) on a vehicle 2 for directional signaling purposes. The output of the light source 23 can only serve to warn vehicles that are in front and cannot be used to warn other vehicles that are behind or that are on the sides. In addition, the light source 23 is generally a resistive lamp that generates a large amount of heat during operation. The heat generated by the light source 23 can aggravate glare of the sideview mirror 21, and thus has an adverse affect on safety when driving at night.

### SUMMARY OF THE INVENTION

Therefore, the main object of the present invention is to provide a vehicular component with an electroluminescent signaling device that can overcome the aforesaid drawbacks associated with the prior art.

Accordingly, the vehicular component of this invention comprises a body part and an electroluminescent signaling device. The signaling device includes a flexible electroluminescent light source strand mounted on the body part, and is adapted to be connected to and controlled by a light controller of a vehicle so as to enable the light source strand to radiate a light output for signaling purposes.

Preferably, the vehicular component is embodied in a sideview mirror, a rear windshield, a door handle or a vehicle body of a vehicle.

### BRIEF DESCRIPTION OF THE DRAWINGS

Other features and advantages of the present invention will become apparent in the following detailed description of the preferred embodiments with reference to the accompanying drawings, of which:

FIG. 1 illustrates how road accidents can happen in the prior art;

FIG. 2 is a fragmentary perspective view illustrating a vehicle with a conventional sideview mirror that is provided with a light source;

FIG. 3 is a fragmentary perspective view illustrating a vehicle that incorporates the first preferred embodiment of a vehicular component with an electroluminescent signaling device according to the present invention;

FIG. 4 is a perspective view of the electroluminescent signaling device of the first preferred embodiment;

FIG. 5 is a circuit block diagram illustrating the connection of the electroluminescent signaling device of the first preferred embodiment to a directional light controller;

FIG. 6 illustrates a body part of the second preferred embodiment of a vehicular component according to the present invention;

FIG. 7 illustrates a body part of the third preferred embodiment of a vehicular component according to the present invention; and

FIG. 8 is a perspective view illustrating a vehicle that incorporates other embodiments of the vehicular component according to the present invention.

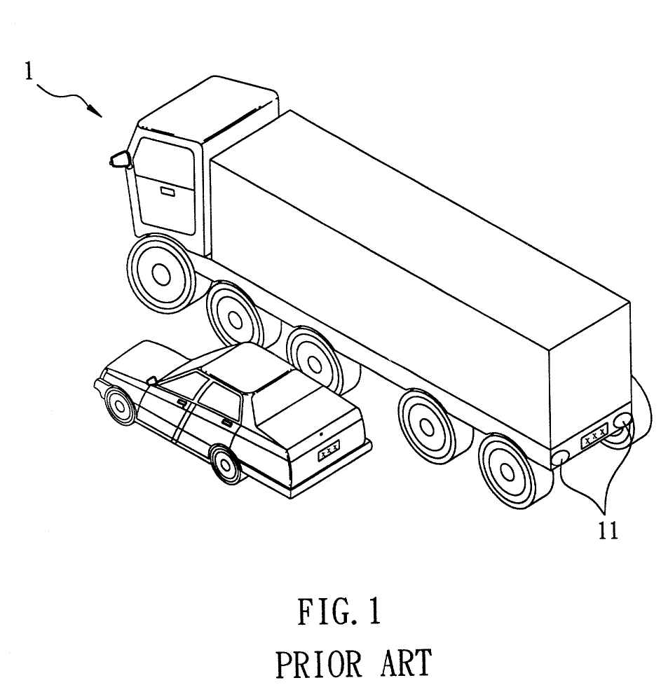

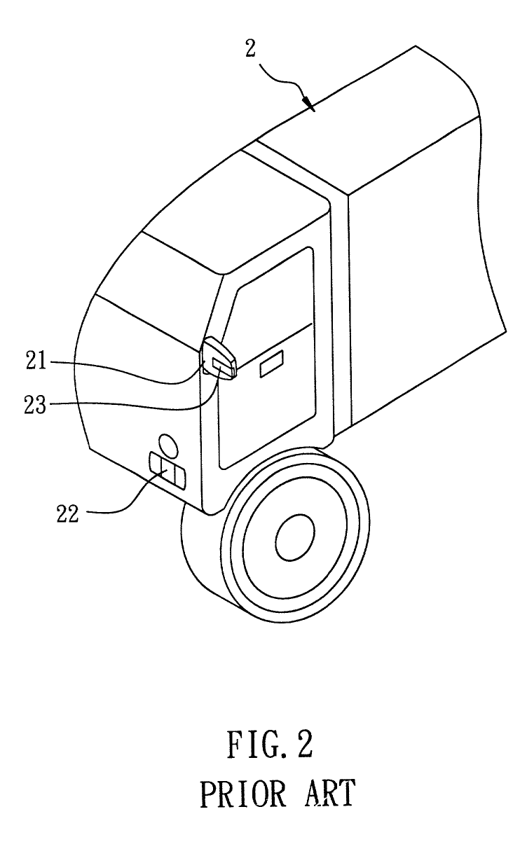

### DETAILED DESCRIPTION OF THE PREFERRED EMBODIMENTS

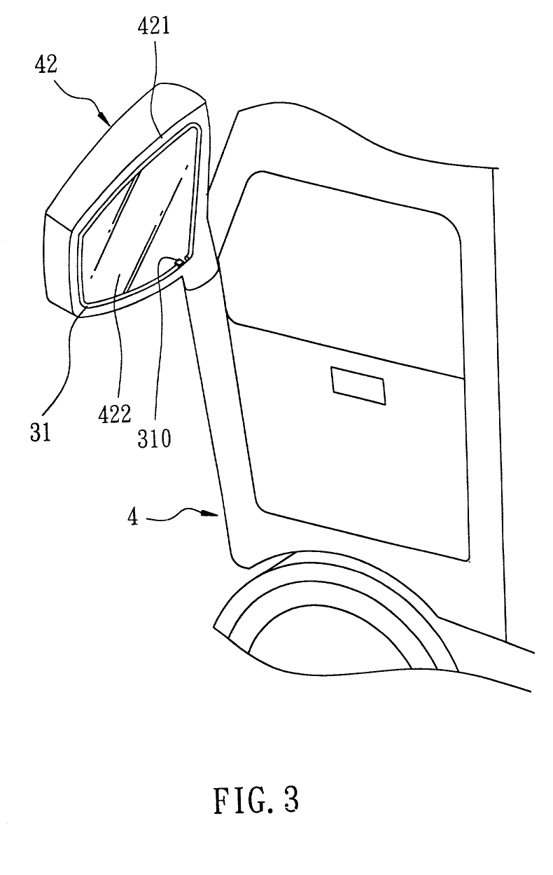

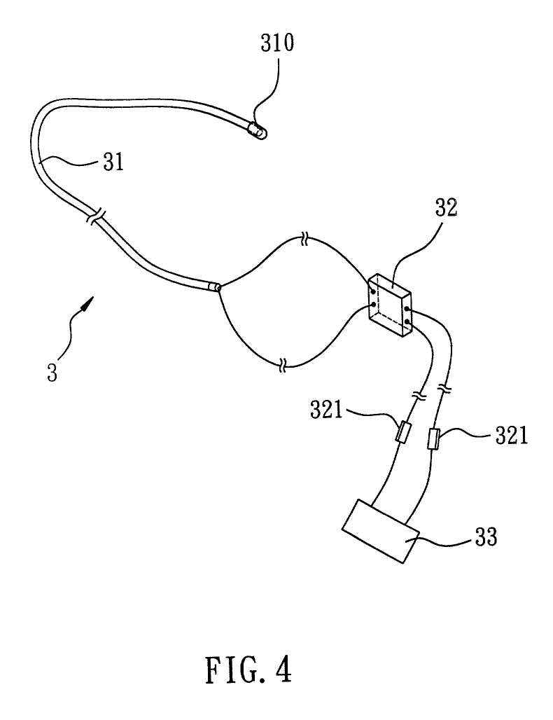

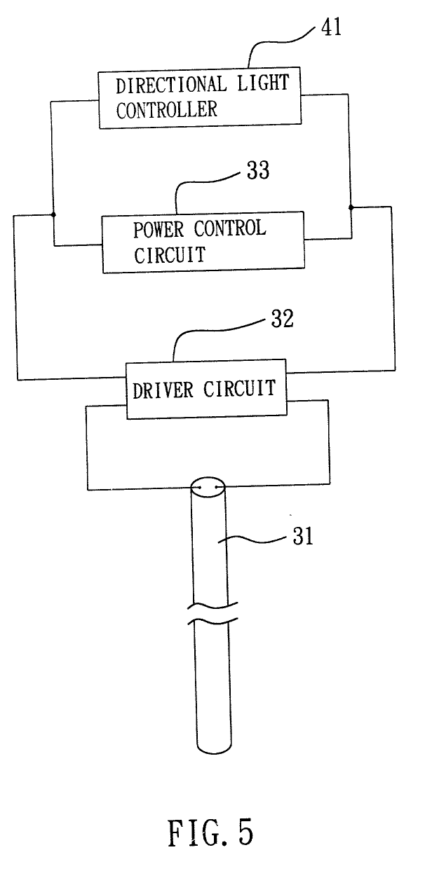

Referring to FIGS. 3, 4 and 5, the first preferred embodiment of a vehicular component according to the present invention is shown to be embodied in a sideview mirror 42 that has a body part adapted to be mounted on a vehicle body of a vehicle 4 in a conventional manner. The body part of the sideview mirror 42 includes a mirror housing 421 having a viewing side, and a mirror piece 422 mounted on the viewing side of the mirror housing 421. The sideview mirror 42 further comprises an electroluminescent signaling device 3 that includes a flexible electroluminescent light source strand 31, a driver circuit 32 coupled to the light source strand 31, and a power control circuit 33 coupled to the driver circuit 32 via a pair of clamps 321. The power control circuit 33 and the driver circuit 32 can be concealed in appropriate locations of the vehicle 4. In this embodiment, the power control circuit 33 is mounted in the vehicle 4, whereas the driver circuit 32 is mounted in the mirror housing 421. In addition, the light source strand 31 of the signaling device 3 of this embodiment is secured to and is disposed to surround the mirror piece 422. The light source strand 31 has an insulated end 31, which is formed by coating a distal end of the light source strand 31 with an insulator film 310.

The power control circuit 33 is adapted to be connected to a directional light controller 41 of the vehicle 4. Thus, the power control circuit 33 can be activated by the light controller 41 so as to generate a first voltage output when turning or changing lanes. Upon receipt of the first voltage output, the driver circuit 32 generates a second voltage output greater than the first voltage output. The second voltage output serves as an operating voltage for driving the light source strand 31 to radiate light in a known manner. Preferably, the first voltage output generated by the power control circuit 33 is a periodic output such that the light source strand 31 is driven by the driver circuit 32 so as to generate a blinking light output.

Because the light source strand 31 surrounds the mirror piece 422 that is mounted on the viewing side of the mirror housing 421, it is visible to drivers of vehicles that are behind or that are on the sides. As such, safety can be enhanced when the vehicle 4 is equipped with the sideview mirror 42 of this invention. Moreover, in view of the relatively low heat that is generated by the electroluminescent light output of the light source strand 31, glare of the sideview mirror 42 is not aggravated.

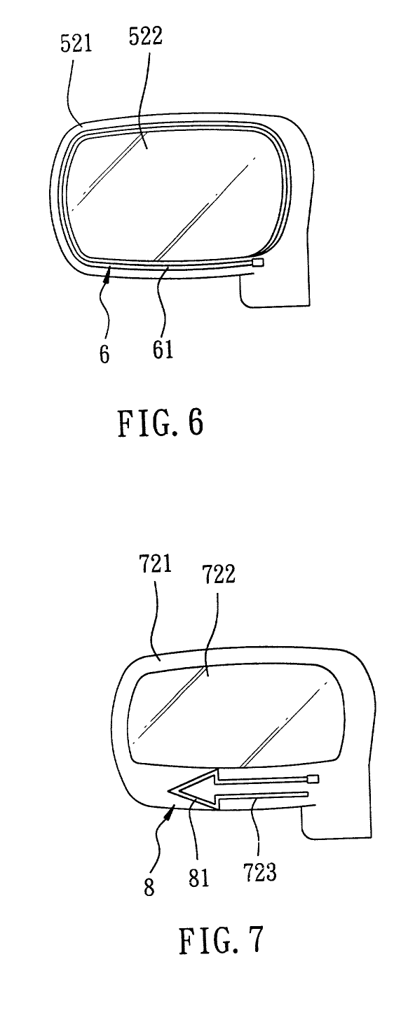

FIG. 6 illustrates a sideview mirror 6 according to the second preferred embodiment of this invention. Unlike the first preferred embodiment, a flexible electroluminescent light source strand 61 is disposed to surround a mirror piece 522 but is secured to the viewing side of a mirror housing 521.

FIG. 7 illustrates a sideview mirror 8 according to the third preferred embodiment of this invention. Unlike the second preferred embodiment, the viewing side of a mirror housing 721 is formed with a recess 723 adjacent to a mirror piece 722. The recess 723 forms an outline of an arrowhead, and has one end formed with a hole (not visible) for access into the mirror housing 721. A flexible electroluminescent light source strand 81 is secured to the viewing side in the recess 723. Particularly, the light source strand 81 extends along the recess 723, and has one end extending into the mirror housing 721 via the hole in the recess 723 to connect with the driver circuit (not shown) in the mirror housing 721.

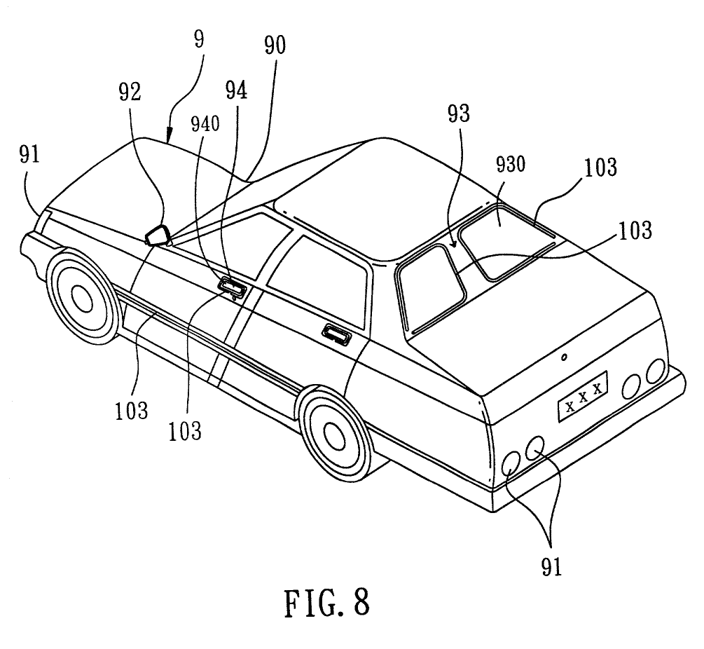

FIG. 8 illustrates a vehicle 9 that incorporates other embodiments of the vehicular component according to the present invention. Aside from a sideview mirror 92 similar to the previous embodiments, the vehicular component can be further embodied in a rear windshield 93 with a pair of flexible electroluminescent light source strands 103 secured to a windshield body 930, a door handle 94 with a flexible electroluminescent light source strand 103 that is disposed to surround a handle body 940, or a vehicle body 90 with a pair of flexible electroluminescent light source strands 103 secured to its sides. Like the previous embodiments, the light source strands 103 are operable concurrently with directional lights 91 on the vehicle body 90 for directional signaling purposes.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A vehicular component comprising:
a body part; and
an electroluminescent signaling device including a flexible electroluminescent light source strand mounted on said body part, said electroluminescent signaling device being adapted to be connected to and controlled by a light controller of a vehicle so as to enable said light source strand to radiate a light output for signaling purposes.

2. The vehicular component as claimed in claim 1, wherein said vehicular component is a sideview mirror adapted to be mounted on a vehicle body of the vehicle, said body part including a mirror housing having a viewing side, and a mirror piece mounted on said viewing side of said mirror housing.

3. The vehicular component as claimed in claim 2, wherein said light source strand is secured to and is disposed to surround said mirror piece.

4. The vehicular component as claimed in claim 2, wherein said light source strand is secured to said viewing side of said mirror housing and is disposed to surround said mirror piece.

5. The vehicular component as claimed in claim 2, wherein said viewing side of said mirror housing is formed with a recess adjacent to said mirror piece, said light source strand being secured to said viewing side in said recess.

6. The vehicular component as claimed in claim 5, wherein said recess forms an outline of an arrowhead.

7. The vehicular component as claimed in claim 1, wherein said electroluminescent signaling device further includes a power control circuit adapted to be connected to the light controller, and a driver circuit coupled to said power control circuit and said light source strand,
said power control circuit being adapted to be activated by the light controller so as to generate a first voltage output,
said driver circuit generating a second voltage output greater than the first voltage output upon receipt of the first voltage output, the second voltage output serving as an operating voltage for driving said light source strand to radiate light.

8. The vehicular component as claimed in claim 7, wherein the first voltage output generated by said power control circuit is a periodic output such that said light source strand is driven by said driver circuit so as to generate a blinking light output.

9. The vehicular component as claimed in claim 7, wherein said vehicular component is a sideview mirror adapted to be mounted on a vehicle body of the vehicle, said body part including a mirror housing having a viewing side, and a mirror piece mounted on said viewing side.

10. The vehicular component as claimed in claim 9, wherein said driver circuit is mounted in said mirror housing, and said light source strand is disposed to surround said mirror piece.

11. The vehicular component as claimed in claim 1, wherein said vehicular component is a door handle adapted to be mounted on a vehicle body of the vehicle, said body part including a handle body, said light source strand being disposed to surround said handle body.

12. The vehicular component as claimed in claim 1, wherein said vehicular component is a rear windshield adapted to be mounted on a vehicle body of the vehicle, said body part including a windshield body, said light source strand being secured to said windshield body.

13. The vehicular component as claimed in claim 1, wherein said body part is a vehicle body, and said light source strand is secured to one side of said vehicle body.
